(19) United States
(12) Patent Application Publication
(10) Pub. No.: US 2016/0031157 A1
(43) Pub. Date: Feb. 4, 2016

(54) DIELECTRIC ENRYPTION AND ENDOTHERMOIC HEATING OF ADDITIVE MANUFACTURING PROCESS USING MAGNETIC EXCITATION AND HEATLESS INDUCTION SOURCES

(71) Applicants: Paul Reep, Ojai, CA (US); Richard Weddle, Ojai, CA (US)

(72) Inventors: Paul Reep, Ojai, CA (US); Richard Weddle, Ojai, CA (US)

(21) Appl. No.: 14/662,125

(22) Filed: Mar. 18, 2015

Related U.S. Application Data
(60) Provisional application No. 61/969,083, filed on Mar. 21, 2014.

(51) Int. Cl. B29C 67/00; B29C 71/00

(52) U.S. Cl. CPC B29C 67/0081; B29C 71/0072; B29K 2101/00

(57) ABSTRACT

A feedstock material can be doped with magnetic particles, and an inductive coil can be used to induce an endothermic reaction within the feedstock material, due to the presence of the magnetic particles within the feedstock material, during the creation (or printing) of an object. An inductive coil can also be used to create magnetic fields for manipulating the position and/or orientation of the magnetic particles within the feedstock material before, in situ, and after the AM process. A unique signature can be created by the interaction between a magnetic field and magnetic particles within the feedstock material. DNA can be added to the magnetic particles as a means for providing identification to a manufactured component or for identifying one or more characteristics of the component or portion of the component.

### CROSS-REFERENCE TO RELATED APPLICATIONS

This application claims the benefit of U.S. Provisional Patent Application No. 61/969,083 which was filed on Mar. 21, 2014.

### BACKGROUND

Additive manufacturing (AM) refers to the industrial technologies for ‘printing’ or laying down objects layer-by-layer. This type of manufacturing is colloquially referred to as ‘3D printing.’ AM relies on a computer and 3D modeling software to produce a parsed and layered model of the object to be ‘printed’ and may include not only layer by layer but also a ‘particle by particle’ additive process. Data is input into the AM printer using specific software to lay down or add successive layers of liquid, powder, particles, nano-blocks, sheet materials, or other feedstock, in a layer-upon-layer fashion that fabricates the 3D object. The feedstock for AM systems may be dispensed by several methods such as extrusion deposition, wire deposition, granular deposition, powder-bed, inkjet-head deposition, lamination, and photopolymerization and may include particle by particle placement technology. The terms ‘feedstock’ or ‘materials’ apply to powders, viscous liquids, polymeric materials, metals, wires, ceramics, adhesives, and other materials used as raw materials for AM.

### BRIEF SUMMARY

The present invention relates to additive manufacturing (“AM” or “3D printing”). More particularly, the present invention is directed to an AM system and method which employs an inductive coil during and/or after the AM process. In some embodiments, a feedstock material can be doped with magnetic particles, and an inductive coil can be used to induce an endothermic reaction within the feedstock material, due to the presence of the magnetic particles within the feedstock material, during the creation (or printing) of an object. In other embodiments, an inductive coil can be used to create magnetic fields for manipulating the position and/or orientation of the magnetic particles within the feedstock material both before and during the AM process. In some embodiments, DNA can be added to the magnetic particles as a means for providing identification to a manufactured component or for identifying one or more characteristics of the component or portion of the component.

In one embodiment, the present invention is implemented as a method for creating an object via an additive manufacturing process. A magnetic additive can be added to a feedstock material. An object can be produced, via an additive manufacturing process, from the feedstock material that contains the magnetic additive. An inductive coil can be used to induce an endothermic reaction within the object, the endothermic reaction causing a change to at least one characteristic of the object.

In another embodiment, the present invention is implemented as a method for creating an object via an additive manufacturing process. A magnetic additive can be added to a feedstock material. An object can be produced, via an additive manufacturing process, from the feedstock material that contains the magnetic additive. A magnetic device can be used to detect the presence of the magnetic additive within one or more portions of the object.

In another embodiment, the present invention is implemented as a method for creating an object via an additive manufacturing process. A magnetic additive can be added to a feedstock material. The magnetic additive can include synthetic or natural DNA. An object can be produced, via an additive manufacturing process, from the feedstock material that contains the magnetic additive and the DNA.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example additive manufacturing system having a print area surrounded by an inductive coil;

FIG. 2 illustrates an example additive manufacturing system having inductive coils surrounding a print area and a supply area; and

FIG. 3 illustrates an example additive manufacturing system having a multi-axis inductive coil.

### DETAILED DESCRIPTION

The present invention is generally directed to embodiments for introducing magnetically or potential magnetically active alloys (“magnetic additives”) into polymer/resin-based substrates and feedstock material and other metallic non-magnetic feedstock material (collectively “feedstock material”) which is used in the AM process to produce objects. By introducing magnetic additives into the feedstock material used to produce AM objects, the feedstock material can then be manipulated using a magnetic field produced by an inductive coil.

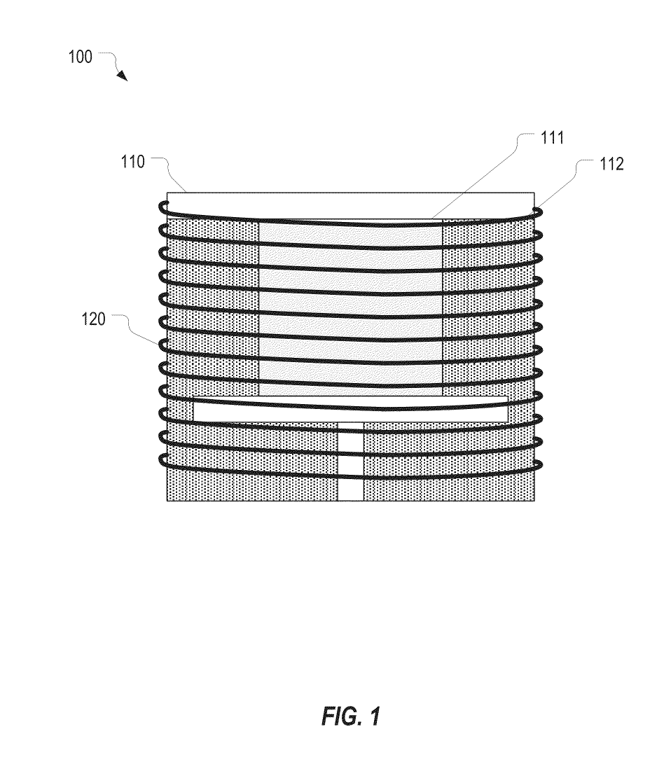

In some embodiments, an AM system can include an inductive coil that substantially surrounds the object or portion of the object. In some embodiments, the inductive coil may be positioned around the printing area of an AM system so that the printed object can be heat treated while being printed or immediately thereafter. For example, FIG. 1 depicts an AM system 100 having a print area 110 that is surrounded by an inductive coil 120. Coil 120 can be driven to cause a magnetic field to be applied to object 111 that is being printed from feedstock material 112. The magnetic field can induce an endothermic reaction within object 111 due to the presence of magnetic additives within feedstock material 112. AM system 100 is an example of a stereolithography AM system which uses a laser (not shown) to solidify liquid feedstock material 112 into object 111. However, a similar inductive coil could be employed in other types of AM systems.

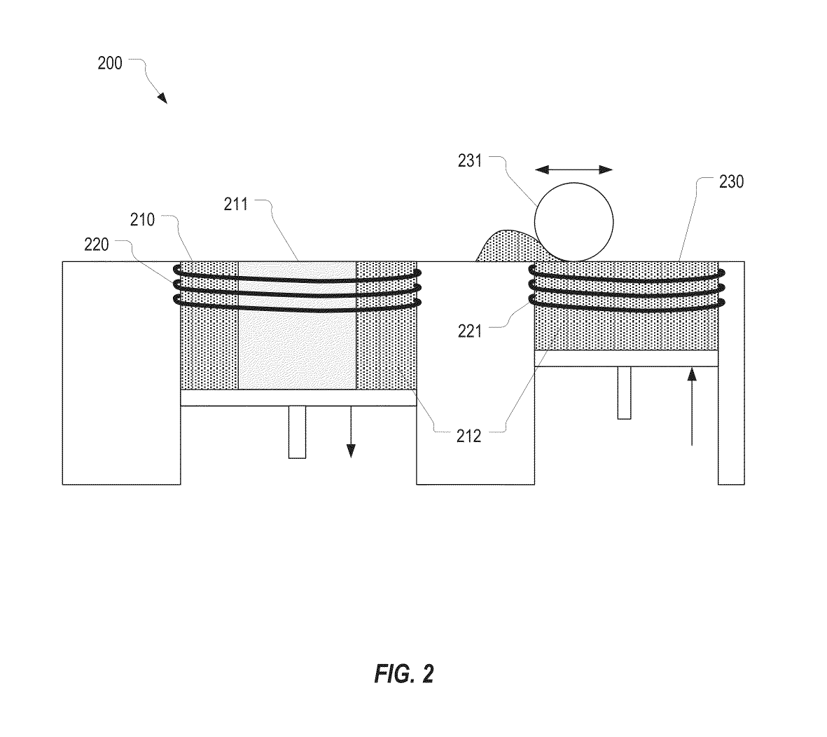

FIG. 2 illustrates an example of another AM system 200 that includes inductive coils 220, 221. AM system 200 includes a print area 210 around which inductive coil 220 is positioned. Inductive coil 220 can function in a similar manner as inductive coil 120 by inducing an endothermic reaction within object 211 that is produced from powder feedstock material 212. AM system 200 also includes a supply area 230 from which powder feedstock material 212 is supplied to print area 210 by means of a roller 231. As shown, a second inductive coil 221 can surround supply area 230 to induce an endothermic reaction within feedstock material 212 while it is present within supply area 230.

In FIG. 1, coil 120 is shown as extending substantially along the entire height of print area 110 while in FIG. 2, coils 220 and 221 are shown as extending along only a portion of the height of print area 210 and supply area 230 respectively. However, in each case, the respective coil could extend a different amount along the height of the respective area. For example, the configuration of coil 120 may be preferred if it is desired to simultaneously induce an endothermic reaction throughout the entirety of the printed object. In contrast, the configuration of coil 220 may be preferred if it is desired to induce an endothermic reaction in one or a few layers of a printed object (e.g., only within a layer currently being printed or only within one or more layers that were most recently printed). In some embodiments, an inductive coil may be configured to move along the height of the print area or other area to allow the magnetic field to be targeted to a particular area of the printed object.

In other embodiments, rather than positioning an inductive coil around a print area or a supply area of an AM system, the inductive coil may be positioned around a separate area where the object is moved for heat treatment after being printed.

In the above described embodiments, the inductive coil can be driven prior to, during, or after the printing process to create a magnetic field which in turn will induce an endothermic reaction within the feedstock material because of the presence of the magnetic additives within the feedstock material. This endothermic reaction can cure the feedstock material or otherwise affect a property of the feedstock material without requiring an external source of heat.

Unlike traditional AM processes which employ a conventional oven or ultra violet lamps, the present invention can cure the feedstock material or paint or other surface treatment using relatively little energy. Further, induction curing is generally faster and provides greater temperature stability including greater control over time at temperature, rise-rate, decay rate, annealing, etc. Where the object requires paint or an enameled surface, the magnetic additives can be drawn towards the surface of the object (using the techniques described below) so that heat is induced near the surface of the object.

In addition to allowing the feedstock material to be heat treated via an inductive coil, the incorporation of magnetic additives within the feedstock material can also provide a feedback mechanism during or after the printing process. Using a magnetic sensor (e.g., an inductive coil based sensor), the degree or amount of attraction force exhibited by a printed object or the amount of heat generated within the printed object in a prescribed amount of time can provide surrogate or indirect identifying characteristics needed to ensure the correct feedstock formulation and amounts of feedstock material are being delivered to the correct process devices. For example, if multiple types of feedstock material are being used to print an object, a magnetic sensor can be used to detect the presence of magnetic additives to determine whether the proper mixing is occurring (e.g., if the feedstock materials are mixed) or whether the proper feedstock material or materials are being printed at the proper positions of the object (e.g., if the feedstock materials are not being mixed).

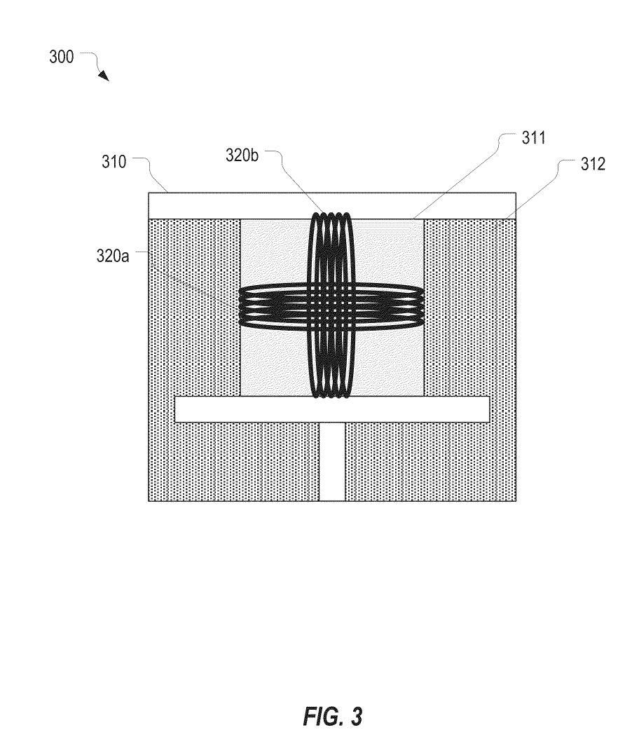

FIG. 3 illustrates an embodiment of an AM system 300 where a multi-axis inductive coil is used to selectively apply a magnetic force to a printed object. This multi-axis inductive coil includes a horizontal coil 320a and a vertical coil 320b. Unlike the coils depicted in FIGS. 1 and 2, this multi-axis inductive coil does not surround the print or other area. Instead, the multi-axis inductive coil is configured to be repositionable around the print area 310 or other area. For example, the multi-axis inductive coil could be positioned adjacent a particular surface of the printed object. In this way, a targeted magnetic field can be generated for detecting characteristics of the printed object 311 (e.g., the location and/or concentration of magnetic additives within the printed object) or for manipulating the position of the magnetic additives within the printed object (e.g., by applying the magnetic field while the magnetic additives are still able to move within the object 311 or feedstock material 312). A single axis inductive coil or an inductive coil with more than two axes could also be used in these embodiments. Also, this type of repositionable inductive coil could be used in a similar manner in a supply area (such as supply area 230) or other area of an AM system.

With regards to AM system 200, an inductive coil could be used to selectively draw magnetic additives towards the surface of the supply area so that a desired concentration of magnetic additives will be present in a particular layer or layers of the printed object. Similarly, an inductive coil could be used to selectively draw magnetic additives towards a particular portion of print area 210 so that a desired concentration of magnetic additives will be present in a particular portion of a printed object. An inductive coil could also be used to manipulate the position of magnetic additives in other ways.

In some embodiments, the magnetic additives can include DNA from extremophile organisms (particularly those that are resistant to and can survive in extremely high temperatures) or synthetic DNA. Such DNA may be embedded, packaged, or encapsulated with the magnetic additives. Encapsulation can be accomplished via a hybridization probe or ligation technique. Once incorporated into a printed object, the DNA can serve as a form of authentication information. In other words, the DNA can later be detected within the object to provide a unique identification for the object.

In some embodiments, it may be desirable to concentrate or dilute the magnetic additives, and therefore the DNA, while the feedstock is in an aqueous or colloidal phase. This can be accomplished using an inductive coil (e.g., the multi-axis coil shown in FIG. 3) or other magnetic device to attract the magnetic additives to the desired regions of the component. Controlling the position of the DNA within the object in this manner can aid and simplify sampling and analysis of the DNA (e.g., by concentrating the DNA in known locations).

In some embodiments, binding chemistry may be used to help align and/or configure certain formulations of feedstock materials. Polymers whose valences or electric charge state allow for an affinity for magnetic particles/molecules can be used. Controlled, precise agglomeration and distribution could be useful in a variety of instances such as homogenous blending of material, vector alignment, particle or filament orientation, etc. These controlled techniques using magnetic particles can be manipulated using induction engines or magnetic solenoids.

The present invention can be useful for various purposes. For example, the present invention can facilitate part authentication and prevent counterfeiting. Forensic testing is also possible on components fabricated with DNA using a simple dry sample preparation technique, and hand-held polymerase chain reaction (PCR) test, or by matching thermal density against mass.

Suitable materials that can be used as an magnetic additive include: Ferrite, Alnico, Bismanol, Cunife, Fernico Alloys, Intermetallic such as Heusler Alloy, Nickel, or Nickel Cobalt Alloy, Metglas, Mictomagnetic Alloy, MKM Steel, Neodymium, Permalloy, Samarium, Sendust, Supermalloy, Iron-Neodymium-Boron, Aluminum-Nickel-Cobalt, Samarium-Cobalt, Neodymium, Iron and Boron Nd2Fe14B, Radioactive candidate additives including gadolinium (Gd), Radioactive actinide curium (Cm), Alkaline-earth cerates and zirconate based perovskite materials including Acceptor doped SrCe03, BaCeO3 and BaZrO3, and Multiferroics.

Suitable organisms whose DNA could be used in embodiments of the present invention include: Acidophile, Alkaliphile, Barophile, Endolith, Halophile, Hyperthermophile, Hypolith, Lithoautotroph, Metalotolerant, Oligotroph, Piezophile, Polyextremophile, Psychrophile/Cryophile, Radioresistant, Thermophile, and Xerophile.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed:

1. A method for creating an object via an additive manufacturing process, the method comprising:
adding a magnetic additive to a feedstock material;
producing, via an additive manufacturing process, an object from the feedstock material that contains the magnetic additive; and
using an inductive coil to induce an endothermic reaction within the object, the endothermic reaction causing a change to at least one characteristic of the object.

2. The method of claim 1, wherein using an inductive coil to induce an endothermic reaction within the object comprises:
positioning the object within the inductive coil while the inductive coil generates a magnetic field.

3. The method of claim 1, wherein causing a change to at least one characteristic of the object comprises curing the feedstock material.

4. The method of claim 1, wherein causing a change to at least one characteristic of the object comprises curing paint or other surface treatment on the object.

5. The method of claim 1, wherein the inductive coil surrounds the object.

6. The method of claim 1, further comprising:
using a second inductive coil to create a magnetic force for attracting the magnetic additive to a surface of the object while the feedstock material is in a liquid or colloidal state.

7. The method of claim 6, wherein the second inductive coil is positioned adjacent to the surface of the object.

8. The method of claim 1, wherein the magnetic additive includes DNA.

9. A method for creating an object via an additive manufacturing process, the method comprising:
adding a magnetic additive to a feedstock material;
producing, via an additive manufacturing process, an object from the feedstock material that contains the magnetic additive; and
using a magnetic device to detect the presence of the magnetic additive within one or more portions of the object.

10. The method of claim 9, wherein detecting the presence of the magnetic additive within one or more portions of the object comprises detecting a heat level generated within the one or more portions of the object when subject to a magnetic field generated by the magnetic device.

11. The method of claim 9, wherein detecting the presence of the magnetic additive within one or more portions of the object comprises detecting a level of magnetic attraction between the one or more portions of the object and the magnetic device.

12. The method of claim 9, further comprising:
identifying an amount of the feedstock material in the one or more portions of the object based on the detection of the presence of the magnetic additive within the one or more portions.

13. The method of claim 12, further comprising:
altering the additive manufacturing process during the creation of the object based on the identified amount of the feedstock material in the one or more portions.

14. The method of claim 9, wherein the magnetic additive includes DNA.

15. The method of claim 1, wherein the feedstock material is one or more of a thermoplastic or a polymer.

16. A method for creating an object via an additive manufacturing process, the method comprising:
adding a magnetic additive to a feedstock material, the magnetic additive including DNA; and
producing, via an additive manufacturing process, an object from the feedstock material that contains the magnetic additive and the DNA.

17. The method of claim 16, further comprising:
using a magnetic device to attract the magnetic additive and the DNA to one or more portions of the object.

18. The method of claim 17, wherein the one or more portions comprise a set of portions that uniquely identify the object.

19. The method of claim 17, further comprising:
using a magnetic device to detect the magnetic additive in the one or more portions of the object.

20. The method of claim 17, further comprising;
detecting the DNA in the one or more portions.
